(19) United States
(12) Patent Application Publication
(10) Pub. No.: US 2025/0346801 A1
(43) Pub. Date: Nov. 13, 2025

(54) Method for Removing Metal Contaminants

(71) Applicant: Cameron International Corporation, Houston, TX (US)

(72) Inventors: Oluchukwu Aloke, Aberdeen (GB); Alexander Colin Nelson, Stavanger (NO); Erin Temple, Aberdeen (GB)

(21) Appl. No.: 19/203,582

(22) Filed: May 9, 2025

Related U.S. Application Data
(60) Provisional application No. 63/645,599, filed on May 10, 2024.

(51) Int. Cl. C09K 8/532

(52) U.S. Cl. CPC C09K 8/532; C09K 2208/20

(57) ABSTRACT

Methods and compositions for dissolving metal containing scale are described herein. An aqueous dissolver solution is applied to a metal surface having metal containing scale and the contact is maintained for a duration selected to reduce or remove the scale.

### CROSS-REFERENCE TO RELATED APPLICATION

This application claims the benefit of U.S. Provisional Patent Application No. 63/645,599, filed May 10, 2024, which is entirely incorporated herein by reference.

### BACKGROUND

### Field of the Disclosure

The present disclosure is related to compositions and methods of managing scale that deposits on well production equipment.

### Background

Scale on oilfield equipment, and other well production equipment, can pose significant challenges to the efficiency of such equipment and to the operability of the equipment and the production processes. Scaling of equipment can occur when an incompatible aqueous material comes into contact with equipment surfaces, or due to changes in operating conditions that render previously compatible materials incompatible. In one example, radioactive Pb²¹⁰ can precipitate out of aqueous solution onto equipment surfaces, giving rise to risks in handling and management of the deposits.

There is a need for methods and compositions useful for managing metal-containing scale deposits on metal surfaces.

### SUMMARY

Embodiments described herein provide compositions and methods for managing scale that deposits on well production equipment.

In one aspect, a method is provided for removing materials from an apparatus surface. The method includes contacting an aqueous dissolver solution including a dissolver having the formula [C]⁺[A]⁻, with the apparatus surface having a metal containing scale and maintaining contact between the aqueous dissolver solution and the metal containing scale for a duration selected to remove at least a portion of the scale. In the formula [C]⁺[A]⁻, the [C]⁺ includes ions from Groups 1, 2, 8, 12, 13, or combinations thereof. [A]⁻ includes at least nitrate ions, preferably nitrate ions.

In one aspect, a method is provided for removing materials from metal surfaces. The method includes circulating an aqueous dissolver solution through a wellbore having one or more metal surfaces having metal containing scale, wherein the aqueous dissolver solution comprises a dissolver having the formula [C]⁺[A]⁻, and [C]⁺ comprises ions from Groups 1, 2, 8, 12, 13, or combinations thereof, and [A]⁻comprises nitrate ions, maintaining contact between the aqueous dissolver solution and the metal containing scale for a duration selected to remove at least a portion of the scale, and recirculating at least a portion of the aqueous dissolver solution through the wellbore one or more times.

In another aspect described herein, a method is provided including applying an aqueous dissolver solution comprising nitrate ions, aluminum ions, or both, to a metal surface having a metal containing scale, and maintaining contact between the dissolver solution and the scale for a duration selected to remove at least a portion of the scale.

### DETAILED DESCRIPTION

This patent application describes inventive methods and compositions, including embodiments thereof. As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to being used separately or in lieu of one or more other embodiments. It should be understood that no limitation of the scope of the claimed subject matter is thereby intended, any alterations and further modifications in the illustrated embodiments, and any further applications of the principles of the application as illustrated therein would normally occur to one skilled in the art to which the disclosure relates are contemplated herein.

In the following description, numerous details are set forth to provide an understanding of some embodiments of the present disclosure. It is to be understood that the following disclosure provides many different aspects, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described aspects are possible. This description is not to be taken in a limiting sense but rather made merely for the purpose of describing general principles of the implementations. The scope of the implementations described should be ascertained with reference to the claims issued.

Embodiments described herein provide compositions and methods for managing scale that deposits on well production equipment. In one embodiment, methods and compositions for removing scale deposits on metal surfaces of well production equipment are described.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

The use of headings is for purposes of convenience only and does not limit the scope of the present disclosure. Embodiments described herein can be combined with other embodiments.

In an embodiment, a method is provided for removing materials from an apparatus surface. The method includes contacting an aqueous dissolver solution including a dissolver having the formula [C]⁺[A]⁻, with the apparatus surface having a metal containing scale and maintaining contact between the aqueous dissolver solution and the scale for a duration selected to remove at least a portion of the scale. In the formula [C]⁺[A]⁻, the [C]⁺ includes ions from Groups 1, 2, 8, 12, 13, or combinations thereof. [A]⁻ includes at least nitrate ions, preferably nitrate ions.

In one embodiment, the aqueous dissolver solution includes a dissolver, water, an optional activator, an optional scavenger, and combinations thereof.

In one embodiment, the dissolver has the formula [C]⁺[A]⁻, the [C]⁺ as a cation component and [A]⁻ as an anion component. The [C]⁺ cation components may include ions derived from the elements in Groups 1, 2, 8, 12, 13, or combinations thereof. Suitable cations include cations derived from elements selected from the group consisting of aluminum, sodium, calcium, potassium, magnesium, iron, zinc, and combinations thereof. Examples of suitable cations include Al³⁺, Na¹⁺, Ca²⁺, K¹⁺, Mg²⁺, Fe³⁺, Zn²⁺, among others. For the purposes of the present disclosure, the numbering scheme for the Periodic Table Groups is used as described in Chemical and Engineering News, v.63(5), pg. 27 (1985). Therefore, a “group 4 metal” is an element from group 4 of the Periodic Table, for example, Hf, Ti, or Zr.

The [A]⁻ anions include ions, in particular anions, derived from mineral acids. Suitable anions include anions derived from mineral acids, such as nitric acid. An example of a suitable anion is a nitrate anion, NO₃_{^{−}}. In a preferred embodiment, [A]⁻ includes at least nitrate ions (NO₃_{^{−}}). The anion may also be referred to as the oxidizing anion.

In one embodiment, the dissolver is selected from the group consisting of aluminum nitrate, sodium nitrate, calcium nitrate tetrahydrate, potassium nitrate, magnesium nitrate hexahydrate, iron nitrate, zinc nitrate, and combinations thereof.

The dissolver may be in a pure form, 100 wt. %, or in an aqueous solution. In an aqueous solution the dissolver may comprise from about 5 weight percent (wt. %) to about 95 wt. %, such as from about 20 wt. % to about 65 wt. %, for example, about 20 wt. %, about 30 wt. %, about 40 wt. %, or about 50 wt. %, of the aqueous solution, and water may comprise the remainder, such as from about 5 wt. % to about 95 wt. %, such as from about 40 wt. % to about 80 wt. %, for example, about 80 wt. %, about 60 wt. %, or about 50 wt. %, of the aqueous solution.

The dissolver may comprise from about 5 wt. % to about 100 wt. %, such as from about 70 wt. % to about 99 wt. %, such as from about 85 wt. % to about 95 wt. %, for example, about 91 wt. %, of the aqueous dissolver solution, though other amounts are contemplated. Any of the foregoing numbers can be used for the pure form or in the aqueous solution of the dissolver. Any of the foregoing numbers can be used singly to describe an open-ended range or in combination to describe a close-ended range.

The aqueous dissolver solution may include an optional activator. An activator is generally an oxidizing agent that catalyzes reactions between the dissolver and the scale material. Suitable activators include oxidizing agents selected from the group consisting of hydrogen peroxide, organic peroxides, and combinations thereof. An example of a suitable activator is hydrogen peroxide.

If present, the activator may be present in a pure form or in an aqueous solution. In an aqueous solution the activator may comprise from about 10 wt. % to about 80 wt. %, such as from about 20 wt. % to about 70 wt. %, such as from about 30 wt. % to about 50 wt. %, for example, about 20 wt. %, about 30 wt. %, about 40 wt. %, or about 50 wt. %, of the aqueous solution, of the aqueous solution, and water may comprise the remainder, such as from about 20 wt. % to about 90 wt. %, such as from about 30 wt. % to about 80 wt. %, such as from about 50 wt. % to about 70 wt. % for example, for example, about 80 wt. %, about 70 wt. %, about 60 wt. %, or about 50 wt. %, of the aqueous solution, of the aqueous solution. In one embodiment, a hydrogen peroxide solution of 50 wt. % hydrogen peroxide and 50 wt. % water may be used as the activator.

If present, the activator may comprise from about 1 wt. % to about 30 wt. %, such as from about 5 wt. % to about 15 wt. %, for example, about 9 wt. %, of the aqueous dissolver solution, though other amounts are contemplated. In one embodiment, 9 wt. % of a 50 wt. % hydrogen peroxide solution may be used as the activator. Any of the foregoing numbers can be used for the pure form or in the aqueous solution of the dissolver. Any of the foregoing numbers can be used singly to describe an open-ended range or in combination to describe a close-ended range.

In one embodiment, if the activator is present, a weight ratio between the dissolver and the activator may be from 99:1 to 70:30, such as from 95:5 to 85:15, for example, about 91:9 may be used.

The aqueous dissolver solution may include an optional scavenger. In embodiments of the process when the scale is lead sulphide, hydrogen sulphide may form. The scavenger may be included to reduce and/or remove hydrogen sulphide from the scale removal process if it is formed. Suitable scavengers include compounds selected from the group consisting of amines, aldehydes, metal carboxylates, chelates, and combinations thereof. Examples of suitable scavengers include triazine, triazine derivatives, and glyoxal, among others.

If present in the composition, the scavenger may comprise from about 0.5 wt. % to about 10 wt. %, such as from about 1 wt. % to about 8 wt. %, for example, about 5 wt. %, of the aqueous dissolver solution, though other amounts are contemplated. In one embodiment, 1 wt. % of a scavenger, such as 1 wt. % of triazine, may be used.

In one embodiment, the aqueous dissolver solution comprises:
from about 1 wt. % to about 95 wt. % of the dissolver,
from 0 wt. % to about 30 wt. % of the activator,
from 0 wt. % to about 10 wt. % of the scavenger, and
the remainder water, and the total weight percent is 100 wt. %.

In one embodiment, the aqueous dissolver solution comprises:
from about 1 wt. % to about 95 wt. % of the dissolver,
from 5 wt. % to about 30 wt. % of the activator,
from 0 wt. % to about 10 wt. % of the scavenger and,
the remainder water, and the total weight percent is 100 wt. %.

In another embodiment, the aqueous dissolver solution comprises:
from about 5 wt. % to about 95 wt. % of the dissolver,
from about 1 wt. % to about 30 wt. % of the activator,
from about 0.5 wt. % to about 10 wt. % of the scavenger and,
from about 2.5 wt. % to about 93.5 wt. % water, and the total weight percent is 100 wt. %.

In another embodiment, the aqueous dissolver solution comprises: about 91 wt. % of 30 wt. % aluminum nitrate solution, and about 9 wt. % of 50 wt. % hydrogen peroxide solution.

A total weight percent (total wt. %) of the aqueous dissolver solution is based on the total amount of components present in the aqueous dissolver solution.

The aqueous dissolver solution may have a pH from about 1 to about 5, such as from about 2 to about 5, such as from about 2.5 to about 4.0, for example, about 3.5.

The aqueous dissolver solution may include additional components, such as corrosion inhibitors, glycols, solvents, or combinations thereof among other components.

In one embodiment, the aqueous dissolver solutions can be used to remove metal-containing scale material from metal surfaces of well production equipment such as oilfield equipment. Such a solution is brought into contact with a metal surface having metal containing deposits to be removed for a time period effective to dissolve the scale.

Suitable metal surfaces include any corrosion resistant metal and metal alloys. Examples of suitable metal surfaces include a surface material selected from the group consisting of stainless steel, carbon steel, aluminum, lead, copper, nickel, and combinations thereof.

Suitable scale material to be removed may include material selected from the group consisting of lead, lead sulphide, lead oxide, and combinations thereof. The scale material may be radioactive or non-radioactive. An example of a radioactive material is radioactive lead, Pb-210.

Contacting aqueous dissolver solutions to the metal surfaces can consist of one or more treatments. In one embodiment, repeated short-duration treatments, for example two or more contacts for less than 6 hours per contact. Other treatments can expose a metal surface with metal-containing scale to the aqueous dissolver solution, as described above, for 24 hours or more. In one embodiment, contacting the aqueous dissolver solution with the apparatus surface comprises contacting for one or more periods of time for a total time from about 1 hour to about 48 hours, such as from about 6 hours to about 24 hours.

The contacting of aqueous dissolver solutions to the metal surfaces can occur at temperatures from 10° C. to 200° C., such as from about 50° C. to 160° C., such as from about 70° C. to 130° C. In one embodiment, contacting the aqueous dissolver solution with the apparatus surface includes contacting at a temperature from about 10° C. to about 70° C., in the presence of an activator in the aqueous dissolver solution. In another embodiment, contacting the aqueous dissolver solution with the apparatus surface includes contacting at a temperature from about 60° C. to about 200° C., in the absence of an activator in the aqueous dissolver solution (an activator-free aqueous dissolver solution).

Contacting the aqueous dissolver solution with the apparatus surface can remove all or part of a scale buildup by either immersing the metal surface with the scale buildup in the aqueous dissolver solution, and/or by flowing the aqueous dissolver solution along the metal surface with the scale buildup.

In one embodiment, contacting the aqueous dissolver solution with the metal apparatus includes immersing the apparatus in the aqueous dissolver solution. Contacting the aqueous dissolver solution with the apparatus surface can remove all or part of a scale buildup by immersion of the scale buildup in the aqueous dissolver solution for a duration may remove a portion of the scale buildup or all of the scale buildup. The immersion can be accomplished by static contact between fluid and solid, or by flowing contact throughout a scaled object.

The apparatus can include equipment selected from the group consisting of tubing, valves, and combinations thereof, among other equipment used in downhole oil and gas operations. The apparatus can include equipment selected from the group consisting of flowlines, separators, vessels, water treatment facilities, and combinations thereof, among other equipment used in topside oil and gas operations.

The contact can also be accomplished by flowing the aqueous dissolver solution through a scaled object or scaled apparatus, such as a pipe or piece of well production equipment where an inlet and outlet are present. In some cases, the aqueous dissolver solution can be flowed in a loop or recycle circuit that allows aqueous dissolver solution to circulate through the contaminated object continuously. In one embodiment, wherein the apparatus is a tube, contacting the aqueous dissolver solution includes contacting the aqueous dissolver solution along one or more surfaces of the tube. In an embodiment where the apparatus comprises a structure having at least an inlet and an outlet, contacting the aqueous dissolver solution includes contacting the structure as the aqueous dissolver solution flows from the inlet to the outlet. In an embodiment where the apparatus includes a structure having at least an inlet and an outlet, contacting the aqueous dissolver solution includes contacting the structure as the aqueous dissolver solution flows from the inlet to the outlet and recycled back to the inlet to be reflowed.

In one embodiment, a method is provided for removing materials from metal surfaces downhole in a wellbore. The method may include circulating an aqueous dissolver solution through a wellbore having one or more metal surfaces having metal containing scale, maintaining contact between the aqueous dissolver solution and the metal containing scale for a duration selected to remove at least a portion of the scale, and recirculating at least a portion of the aqueous dissolver solution through the wellbore one or more times. Alternatively, the wellbore may be flushed or pumped, or “via bullheading”, with the aqueous dissolver solution for removing materials from any metal surfaces downhole in a wellbore. For such wellbore operations the aqueous dissolver solution may be applied with chemical pumping systems or may be deployed by tools such as coiled tubing. In one embodiment, when the aqueous dissolver solution is used downhole in a wellbore, the aqueous dissolver solution is free of an activator.

In one example of applying the aqueous dissolver solution, the aqueous dissolver solution may be sent downhole in a well system to remove scale. Preferably, the aqueous dissolver solution is activator free for such application. In contrast for a topside or surface use on a surface or apparatus, an aqueous dissolver solution including an activator may be used. Both downhole and topside application may involve reflowing, recycling and/or refreshing the aqueous dissolver solution during application.

In one embodiment, aqueous dissolver solution is applied to a system by a chemical injection pump as either a neat or in some cases a diluted product. The components of the system are left to soak for a period of time in the aqueous dissolver solution where the scale deposit is situated. The aqueous dissolver solution may be agitated either by the displacement of the fluid by another fluid, for example, a KCl brine or base oil, or by the addition of a tool such as if the aqueous dissolver solution was to be applied via coiled tubing. The solution can also be re-circulated to allow the consumption of all of the available fluid if the system allows for this. One example of this process is to treat a decommissioned vessel requiring cleaning prior to disposal onshore.

In one embodiment, nitrate-based aqueous solutions, or solutions having aluminum cations, or solutions having both aluminum cations and nitrate anions, can be used to remove some metal-containing scale from metal surfaces of well production equipment such as oilfield equipment. The solution can also include an activator such as hydrogen peroxide. Such a solution is brought into contact with a metal surface having metal containing deposits to be removed for a time period effective to dissolve the scale. A treatment can consist of repeated short-duration treatments, for example less than 6 hours per contact. Other treatments can expose a metal surface with metal-containing scale to a aqueous dissolver solution, as described above, for 24 hours or more. Such exposures can remove all or part of a scale buildup by immersing the scale buildup in the aqueous dissolver solution for a duration that removes a portion of the scale buildup or all of the scale buildup. The immersion can be accomplished by static contact between fluid and solid, or by flowing the aqueous dissolver solution through a scaled object, such as a pipe or piece of well production equipment where an inlet and outlet are present. In some cases, the aqueous dissolver solution can be flowed in a loop or recycle circuit that allows aqueous dissolver solution to circulate through the contaminated object continuously.

The following examples are put forth to provide those of ordinary skill in the art with a complete disclosure and description of how to make and use embodiments of the present disclosure and are not intended to limit the scope of embodiments of the present disclosure. Efforts have been made to ensure accuracy with respect to numbers used but some experimental errors and deviations should be accounted for.

### EXAMPLES

Examples of compositions described herein and comparative example compositions were made using various materials set out in the Materials and are described further below. Selected properties of the compositions were measured using known test methods.

The dissolvers include several commercial dissolvers and a lead dissolver “LD”, for example, but not limited to, aluminum nitrate in an aqueous solution, according to the compositions described herein. Test materials include dissolvers of 1) PyriSOL at 50% deionized water solution, a chelant based composition; 2) CAL-Acid 2021T+KI+HR 2746 (1.5%) solution, a carboxylic acid based composition; 3) SD-4108 solution, a carboxylic acid based composition; 4) CAL-Acid solution, a carboxylic acid based composition, 5) an aqueous dissolver solution according to the invention without an activator (LD), and 6) an aqueous dissolver solution according to the invention without an activator with an activator (LD with activator).

For the experiments below, the aqueous dissolver solution (LD) includes 100 wt. % of 30 wt. % aluminum nitrate in water, and the aqueous dissolver solution (LD with activator) includes about 91 wt. % of 30 wt. % aluminum nitrate, and about 9 wt. % of 50 wt. % hydrogen peroxide solution in water.

The material to be removed is lead sulphide. Lead sulphide scale is a common problem in well-production equipment.

The test methods to measure the scale removal involved testing the mass of the samples prior to and after treatment and calculating the mass loss. A known amount of the material is added to a known volume of the dissolver fluid and kept at a fixed temperature for a given period of time. The remaining solids are filtered using a 1-micron filter paper, dried and weighed, and the difference is used to calculate the efficiency of the dissolver.

The experimental process includes the dissolution of lead sulphide was performed using mineral samples (galena) and powdered samples and a variety of dissolvers. The powdered samples were in the form of powder of tiny particles (dark grey color with a soft texture), and the mineral samples were generally hard, shiny, angular grey chunks, and generally single pieces of material. The samples denoted “P” for “powder” or “M” for “mineral”. While the powdered sample is closer in texture to the lead sulphide scale obtainable in the field, testing the lead sulphide mineral evaluates the extreme texture of a lead sulphide scale and the rate at which it will dissolve.

Table 1 references the dissolvers described herein used for the tests, and Table 2 shows results. The samples “P” or “M” were treated at different temperatures, and hydrogen peroxide was used as an activator with the lead dissolver solution in the low temperature test, as shown in Table 1. For each test, 100 ml of solution was contacted with about 2 g lead sulphide solid under static conditions for 24 hours. Weight of the solid before and after exposure to each solution was recorded.

TABLE 1
Dissolvers

| Dissolver | |
|---|---|
| Number | Dissolver Solution Reference |
| 1 | PyriSOL 50% solution |
| 2 | CAL-Acid 2021T + KI + HR 2746 (1.5%) |
| | solution |
| 3 | SD-4108 solution |
| 4 | CAL-Acid solution |
| 5 | dissolver without activator (LD) |
| 6 | dissolver with activator (LD with activator) |

TABLE 2
Performance Of Dissolvers on Lead Sulphide Samples

| | | | Initial | Final | % | |
|---|---|---|---|---|---|---|
| Sample | Dissolver | Temp. (C.) | Weight (g) | Weight (g) | Dissolved | H2S |
| P | 1 | 70 | 2.02 | 1.43 | 29.21 | N/A |
| P | 2 | 70 | 2.01 | 1.54 | 23.38 | N/A |
| P | 3 | 70 | 2.01 | 1.66 | 17.41 | N/A |
| P | 4 | 70 | 2.02 | 1.80 | 10.89 | N/A |
| P | 5 | 70 | 2.01 | 1.61 | 19.90 | N/A |
| P | 6 | 70 | 2.01 | 1.07* | 46.77 | N/A |
| P | 1 | 130 | 2.02 | 1.38 | 31.68 | N/A |
| P | 2 | 130 | 2.02 | 0.79 | 60.89 | N/A |
| P | 3 | 130 | 2.01 | 1.58 | 21.39 | N/A |
| P | 4 | 130 | 2.01 | 1.81 | 9.95 | 5 ppm |
| P | 5 | 130 | 2.02 | 0.18 | 91.09 | N/A |
| M | 1 | 70 | 2.22 | 2.22 | 0 | N/A |
| M | 2 | 70 | 2.18 | 2.18 | 0 | N/A |
| M | 3 | 70 | 2.16 | 2.16 | 0 | N/A |
| M | 4 | 70 | 2.10 | 2.10 | 0 | N/A |
| M | 5 | 70 | 2.24 | 2.23 | 0.45 | N/A |
| M | 6 | 70 | 2.21 | 2.10 | 4.98 | N/A |
| M | 1 | 130 | 2.22 | 2.21 | 0.45 | N/A |
| M | 2 | 130 | 2.20 | 2.19 | 0.45 | N/A |
| M | 3 | 130 | 2.19 | 2.18 | 0.46 | N/A |
| M | 4 | 130 | 2.11 | 2.10 | 0.47 | 5 ppm |
| M | 5 | 130 | 2.25 | 1.39 | 38.22 | N/A |

*After water wash

The results in Table 2 show that the dissolver embodiment according to the dissolver compositions described herein was the most effective dissolver at 70° C., when used with hydrogen peroxide activator, and the same dissolver, without activator, was the most effective at 130° C. These results generally show that the dissolver compositions described herein can be used to manage, reduce, and/or eliminate lead sulphate scale in well production equipment. Generally, the mineral sample proved more challenging to dissolve due to its larger thickness and harder texture in comparison to the powdered sample.

Similar tests were performed using lead shots and the same activated lead dissolver used for the tests in Table 2. The lead shots were exposed to static activated lead dissolver (dissolver number 6 of Table 1) for 24 hours at room temperature. Dissolution of the lead shots was 93% by weight. The tests herein show that the dissolver compositions described herein can be used to dissolve lead metal or lead sulphide deposits on metal surfaces of well production equipment.

While the foregoing is directed to embodiments of the present invention, other and further embodiments of the present disclosure may be devised without departing from the basic scope thereof, and the scope thereof is determined by the claims that follow.

### Example Aspects

Implementation examples are described in the following numbered clauses:

Aspect 1: A method for removing materials from an apparatus surface comprising contacting an aqueous dissolver solution comprising a dissolver having the formula [C]⁺[A]⁻, with the apparatus surface having a metal containing scale, and maintaining contact between the aqueous dissolver solution and the metal containing scale for a duration selected to remove at least a portion of the scale, wherein [C]⁺ comprises ions from Groups 1, 2, 8, 12, 13, or combinations thereof.

Aspect 2: The method of Aspect 1, wherein [C]⁺ comprises ions from elements selected from the group consisting of aluminum, sodium, calcium, potassium, magnesium, iron, and zinc, and combinations thereof.

Aspect 3: The method of any combination of Aspects 1-2, wherein [A]⁻ comprises nitrate ions and the dissolver comprises aluminum nitrate, sodium nitrate, calcium nitrate tetrahydrate, potassium nitrate, magnesium nitrate hexahydrate, iron nitrate, zinc nitrate, and combinations thereof.

Aspect 4: The method of any combination of Aspects 1-3, wherein the dissolver is present in the aqueous dissolver solution at a concentration from about 5 wt. % to 100 wt. %

Aspect 5: The method of any combination of Aspects 1-4, wherein the aqueous dissolver solution further comprises an activator.

Aspect 6: The method of Aspect 5, wherein the activator comprises hydrogen peroxide.

Aspect 7: The method of any combination of Aspects 5-6, wherein the activator is present in the aqueous dissolver solution at a concentration from about 1 wt. % to about 30 wt. %, and wherein the total weight percent of the dissolver and activator in the aqueous dissolver solution is 100 wt. %.

Aspect 8: The method of any combination of Aspects 1-7, wherein the metal containing scale is selected from the group consisting of lead, lead sulphide, lead oxide, and combinations thereof.

Aspect 9: The method of any combination of Aspects 1-8, wherein the apparatus surface comprises a material selected from the group consisting of stainless steel, carbon steel, aluminum, lead, lead, copper, nickel, and combinations thereof.

Aspect 10: The method of any combination of Aspects 1-9, wherein the contacting the aqueous dissolver solution with the apparatus surface comprises immersing the apparatus in the aqueous dissolver solution.

Aspect 11: The method of any combination of Aspects 1-10, wherein the apparatus comprises a tube, and the contacting the aqueous dissolver solution comprises contacting the aqueous dissolver solution along one or more surfaces of the tube.

Aspect 12: The method of any combination of Aspects 1-10, wherein the apparatus comprises a structure having at least an inlet and an outlet, and contacting the aqueous dissolver solution comprises contacting the structure as the aqueous dissolver solution is flowing from the inlet to the outlet.

Aspect 13: The method of any combination of Aspects 1-10, wherein the apparatus comprises a structure having at least an inlet and an outlet, and contacting the aqueous dissolver solution comprises contacting the structure as the aqueous dissolver solution flows from the inlet to the outlet and recycled back to the inlet to be reflowed.

Aspect 14: The method of any combination of Aspects 1-13, wherein the contacting the aqueous dissolver solution with the apparatus surface comprises contacting at a temperature from about 10° C. to about 70° C., in the presence of an activator.

Aspect 15: The method of any combination of Aspects 1-13, wherein the contacting the aqueous dissolver solution with the apparatus surface comprises contacting at a temperature from about 60° C. to about 200° C., in the absence of an activator.

Aspect 16: The method of any combination of Aspects 1-15, wherein the contacting the aqueous dissolver solution with the apparatus surface comprises contacting for one or more periods of time for a total time from about 6 hours to about 24 hours.

Aspect 17: The method of any combination of Aspects 1-16, wherein the aqueous dissolver solution has a pH from about 2 to about 5.

Aspect 18: The method of Aspect 1, wherein the aqueous dissolver solution comprises from about 10 wt. % to about 95 wt. % of dissolver, from about 1 wt. % to about 30 wt. % of activator, and the remainder is water wherein the total weight percent of the dissolver, activator, and water in the aqueous dissolver solution is 100 wt. %.

Aspect 19: The method of any combination of Aspects 1-18, wherein the aqueous dissolver solution further comprises a hydrogen sulphide scavenger

Aspect 20: A method for removing materials from metal surfaces comprising circulating an aqueous dissolver solution through a wellbore having one or more metal surfaces having metal containing scale, wherein the aqueous dissolver solution comprises a dissolver having the formula [C]⁺[A]⁻, and [C]⁺ comprises ions from Groups 1, 2, 8, 12, 13, or combinations thereof, and [A]⁻ comprises nitrate ions, maintaining contact between the aqueous dissolver solution and the metal containing scale for a duration selected to remove at least a portion of the scale, and recirculating at least a portion of the aqueous dissolver solution through the wellbore one or more times.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general- purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions, or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for removing materials from an apparatus surface comprising:
contacting an aqueous dissolver solution comprising a dissolver having the formula [C]⁺[A]⁻, with the apparatus surface having a metal containing scale; and
maintaining contact between the aqueous dissolver solution and the metal containing scale for a duration selected to remove at least a portion of the scale, wherein [C]⁺ comprises ions from Groups 1, 2, 8, 12, 13, or combinations thereof.

2. The method claim 1, wherein [C]⁺ comprises ions from elements selected from the group consisting of aluminum, sodium, calcium, potassium, magnesium, iron, and zinc, and combinations thereof.

3. The method claim 2, wherein [A]⁻ comprises nitrate ions and the dissolver comprises aluminum nitrate, sodium nitrate, calcium nitrate tetrahydrate, potassium nitrate, magnesium nitrate hexahydrate, iron nitrate, zinc nitrate, and combinations thereof.

4. The method claim 1, wherein the dissolver is present in the aqueous dissolver solution at a concentration from about 5 wt. % to 100 wt. %.

5. The method claim 1, wherein the aqueous dissolver solution further comprises an activator.

6. The method claim 5, wherein the activator comprises hydrogen peroxide.

7. The method claim 5, wherein the activator is present in the aqueous dissolver solution at a concentration from about 1 wt. % to about 30 wt. %, and wherein the total weight percent of the dissolver and activator in the aqueous dissolver solution is 100 wt. %.

8. The method claim 1, wherein the metal containing scale is selected from the group consisting of lead, lead sulphide, lead oxide, and combinations thereof.

9. The method claim 1, wherein the apparatus surface comprises a material selected from the group consisting of stainless steel, carbon steel, aluminum, lead, lead, copper, nickel, and combinations thereof.

10. The method of claim 1, wherein the contacting the aqueous dissolver solution with the apparatus surface comprises immersing the apparatus in the aqueous dissolver solution.

11. The method of claim 1, wherein the apparatus comprises a tube, and the contacting the aqueous dissolver solution comprises contacting the aqueous dissolver solution along one or more surfaces of the tube.

12. The method of claim 1, wherein the apparatus comprises a structure having at least an inlet and an outlet, and contacting the aqueous dissolver solution comprises contacting the structure as the aqueous dissolver solution is flowing from the inlet to the outlet.

13. The method of claim 1, wherein the apparatus comprises a structure having at least an inlet and an outlet, and contacting the aqueous dissolver solution comprises contacting the structure as the aqueous dissolver solution flows from the inlet to the outlet and recycled back to the inlet to be reflowed.

14. The method of claim 1, wherein the contacting the aqueous dissolver solution with the apparatus surface comprises contacting at a temperature from about 10° C. to about 70° C., in the presence of an activator.

15. The method of claim 1, wherein the contacting the aqueous dissolver solution with the apparatus surface comprises contacting at a temperature from about 60° C. to about 200° C., in the absence of an activator.

16. The method of claim 1, wherein the contacting the aqueous dissolver solution with the apparatus surface comprises contacting for one or more periods of time for a total time from about 6 hours to about 24 hours.

17. The method of claim 1, wherein the aqueous dissolver solution has a pH from about 2 to about 5.

18. The method of claim 1, wherein the aqueous dissolver solution comprises:
from about 10 wt. % to about 95 wt. % of dissolver;
from about 1 wt. % to about 30 wt. % of activator; and
the remainder is water wherein the total weight percent of the dissolver, activator, and water in the aqueous dissolver solution is 100 wt. %.

19. The method of claim 1, wherein the aqueous dissolver solution further comprises a hydrogen sulphide scavenger.

20. A method for removing materials from metal surfaces comprising:
circulating an aqueous dissolver solution through a wellbore having one or more metal surfaces having metal containing scale, wherein the aqueous dissolver solution comprises a dissolver having the formula [C]⁺[A]⁻, and [C]⁺ comprises ions from Groups 1, 2, 8, 12, 13, or combinations thereof, and [A]⁻ comprises nitrate ions;
maintaining contact between the aqueous dissolver solution and the metal containing scale for a duration selected to remove at least a portion of the scale; and
recirculating at least a portion of the aqueous dissolver solution through the wellbore one or more times.
